(19) United States
(12) Patent Application Publication
(10) Pub. No.: US 2014/0327330 A1
(43) Pub. Date: Nov. 6, 2014

(54) DYNAMOELECTRIC MACHINE HAVING ENHANCED ROTOR VENTILATION

(71) Applicant: General Electric Company, Schenectady, NY (US)

(72) Inventors: Christopher Anthony Kaminski, Niskayuna, NY (US); Anthony Salvatore Arrao, Clifton Park, NY (US); Evgeny Victorovich Kazmin, Moscow (RU); Timothy Gerald Schmehl, Clifton Park, NY (US); Dmitry Yurevich Semenov, Moscow (RU); Yury Danilovich Vinitzky, Moscow (RU); Natalja Stanislavovna Voiteko, Moscow (RU)

(21) Appl. No.: 13/823,369

(22) PCT Filed: Jan. 26, 2012
(86) PCT No.: PCT/RU2012/000034

§ 371 Date: Mar. 14, 2013

(51) Int. Cl. H02K 1/32; H02K 3/48

(52) U.S. Cl. CPC H02K 1/32; H02K 3/48
USPC 310/59

(57) ABSTRACT

A rotor and a dynamoelectric machine including a rotor are disclosed. In an embodiment, the rotor includes a rotor body having a plurality of axially extending slots disposed radially about the rotor body, and at least one coil having at least one turn positioned within each of the plurality of axially extending slots. The rotor further includes a plurality of subslots disposed in the rotor body such that each subslot extends axially through the rotor body parallel to an axis of rotation of the rotor body, and is in fluid communication with a radially inner end of a slot; a passageway extending substantially radially outwardly along each axially extending slot for cooling the at least one turn disposed in the slot; and a retaining member in each of the slots for retaining the at least one turn within the slot. Various embodiments provide ventilation via the passageway for cooling the rotor coils.

### BACKGROUND OF THE INVENTION

The invention relates generally to rotors for dynamoelectric machines such as generators, particularly generators operating at a high voltage. More particularly, the invention relates to rotors for such dynamoelectric machines including improved ventilation and creepage provisions.

Conventional large, high speed generators typically include a stator and a rotor, the rotor rotating about a longitudinal axis (axis Z, see FIG. 1) within the stator to convert mechanical energy into electrical energy. The stator typically includes windings from which electrical power is output.

The rotor includes radially cut slots about the circumference of the rotor body, which extend axially along the rotor body. These slots contain the coils which form the rotor field windings for carrying current. The rotor field windings are supported in place against centrifugal forces by using one of a number of different retaining members including, e.g., coil wedges which bear against the slot surfaces. The regions of the coils which extend beyond the axial ends of the rotor body are referred to as end windings, and are supported against centrifugal forces by retaining rings.

Some rotor applications, such as doubly fed induction machines, have higher power requirements than DC rotors in conventional synchronous machines. In these machines, DC windings are replaced by a two-phase or three-phase winding that is uniformly pitched around the circumference of the rotor. The coils operate at relatively high voltages such as, e.g., up to about 5,000 volts. Voltages on the order of those in variable frequency generators (VFGs) have extremely high insulation and cooling requirements, because the coils carry a larger fraction of the total power of the machine. Thus, they require a larger conductive (usually copper) cross section with additional space allocated to ventilation passages to provide the necessary heat removal capability. The larger copper coil cross section adds weight, amplified by the centrifugal forces inherent to a spinning rotor, thereby increasing structural demands on, e.g., the rotor wedges that hold the coils in place. One way to reduce the coil cross section is to cool the coil directly, in a configuration in which cooling gas comes directly into contact with the coil. Such a design must include a number of locations allowing ingress and egress of cooling gas. This necessitates openings in the insulation around the coils, which introduces a requirement for adequate electrical creepage to prevent flashover. However, increasing the size of the creepage blocks to provide the necessary insulation has the undesirable effect of reducing the available radial space in the slots for end windings and other structural components.

### BRIEF DESCRIPTION OF THE INVENTION

A first aspect of the disclosure provides a rotor comprising a rotor body having a plurality of axially extending slots disposed radially about the rotor body; and at least one coil having at least one turn positioned within each of the plurality of axially extending slots. A plurality of subslots are disposed in the rotor body such that each subslot extends axially through the rotor body substantially parallel to an axis of rotation of the rotor body, and is in fluid communication with a radially inner end of a slot; and a passageway extends substantially radially outwardly along each axially extending slot for cooling the plurality of turns disposed in the slot. A retaining member in each of the slots retains the plurality of turns within the slot.

A second aspect of the disclosure provides an electric machine comprising: a rotor including: a rotor body having a plurality of axially extending slots disposed radially about the rotor body; at least one coil having at least one turn positioned within each of the plurality of axially extending slots, a plurality of subslots disposed in the rotor body such that each subslot extends axially through the rotor body parallel to an axis of rotation of the rotor body, and is in fluid communication with a radially inner end of a slot; and a passageway extending substantially radially outwardly along each axially extending slot for cooling the plurality of turns disposed in the slot. A retaining member is positioned in each of the slots for retaining the plurality of turns within the slot.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 depicts a three-dimensional perspective view of a rotor, including cylindrical coordinates used in subsequent figures.

FIG. 2 depicts a three-dimensional view of a portion of a rotor.

FIG. 3 depicts a cross-sectional view of a generator having a rotor and a stator according to embodiments of the invention.

FIGS. 4A-C and FIGS. 5-8 show cross sectional views of a slot 140 (FIG. 2) in accordance with embodiments of the invention.

FIGS. 9-11A, B show cross sectional views of coils in the slot of FIG. 8 along the R-theta plane and R-Z plane in accordance with embodiments of the invention.

FIG. 12 shows a cross sectional view of a slot 140 (FIG. 2) in accordance with an embodiment of the invention.

FIGS. 13-17 show cross sectional views of coils in the slot of FIG. 11 along the R-theta plane and R-Z plane in accordance with embodiments of the invention.

FIGS. 18-20 show cross sectional views of slots 140 (FIG. 2) in accordance with embodiments of the invention.

FIGS. 21-22 show cross sectional views of portion of a rotor in accordance with embodiments of the invention.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

At least one embodiment of the present invention is described below in reference to its application in connection with the operation of a dynamoelectric machine. Although embodiments of the invention are illustrated relative to a dynamoelectric machine in the form of a generator, which may be a two-pole synchronous generator, it is understood that the teachings are equally applicable to other electric machines including, but not limited to, other types of generators such as generators having four or more poles, asynchronous generators with a three-phase rotor winding, doubly fed induction machines such as a variable frequency generator (VFG), and motors. Further, at least one embodiment of the present invention is described below in reference to a nominal size and including a set of nominal dimensions. However, it should be apparent to those skilled in the art that the present invention is likewise applicable to any suitable generator and/or motor. Further, it should be apparent to those skilled in the art that the present invention is likewise applicable to various scales of the nominal size and/or nominal dimensions.

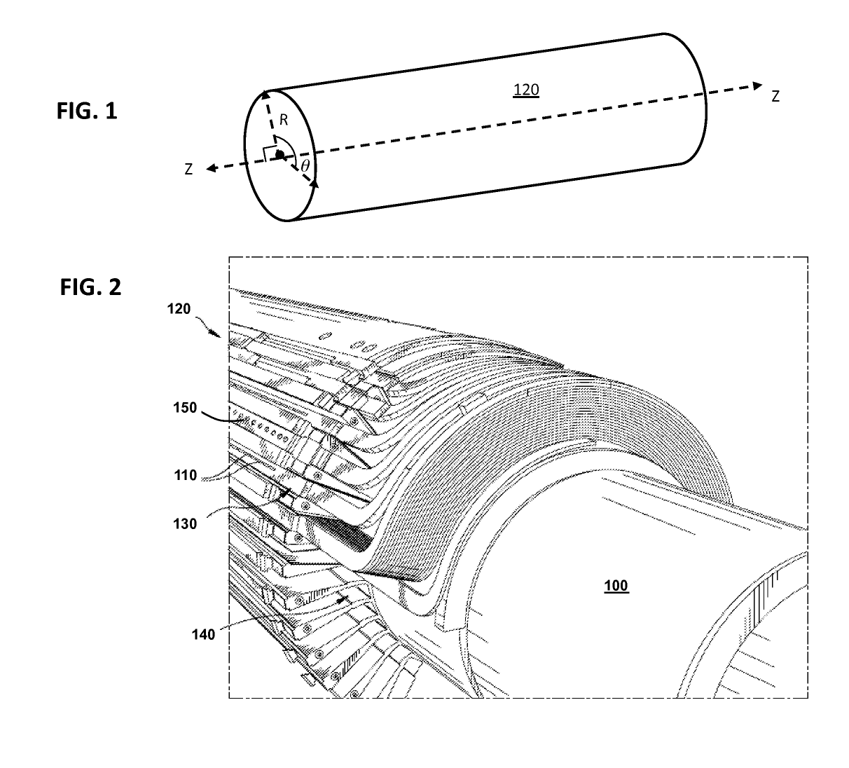

As indicated above, aspects of the invention provide a rotor and an electric machine having improved ventilation and electrical creepage for rotor coils. FIGS. 1-22 show different aspects of a rotor 120 and specifically, configurations providing a rotor utilizing one or more of offset cooling passageways, insulating inserts, and other features described herein and with reference to the figures.

FIG. 1 shows a perspective view of rotor 120, including the cylindrical coordinates used in describing further aspects and embodiments of the invention. FIG. 2 shows additional details of rotor 120, including a spindle 100 and groups of coils 130 disposed about spindle 100. Each group of coils 130 may be contained within a plurality of slots 140, which are disposed radially about the rotor body and extend axially along the rotor 120. Further, each group of coils 130 may contain a plurality of ducts 110 to assist in cooling coils 130. Each slot 140 includes coils 130, which form the rotor field winding.

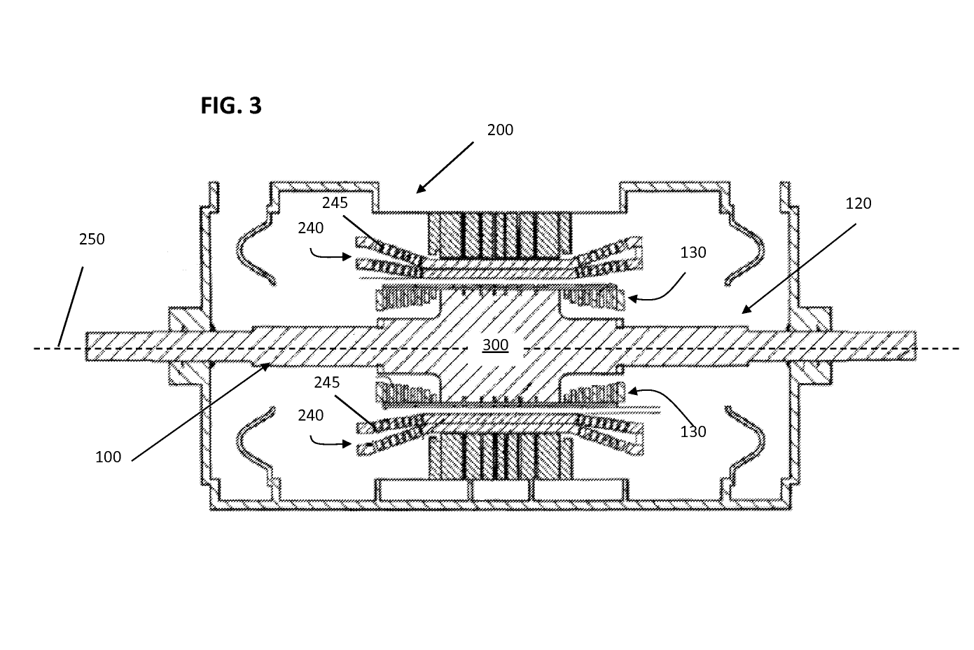

FIG. 3 shows a cross-sectional schematic view of a dynamoelectric machine 200, including stator 240, and rotor 120 positioned within stator 240. Stator 240 includes groups of coils 245, and may comprise any now known or later developed stator structure. As shown, rotor 120 may have spindle 100 and groups of coils 130 disposed about spindle 100. Spindle 100 may be formed of, for example, iron or steel. Rotor 120 rotates about a longitudinal, or Z-axis 250 within stator 240. Rotor 120 further includes rotor body 300, which comprises a multi-pole magnetic core. In the embodiment of rotor 120 depicted in FIG. 3, the magnetic core includes two poles, although this is only one of many possible embodiments.

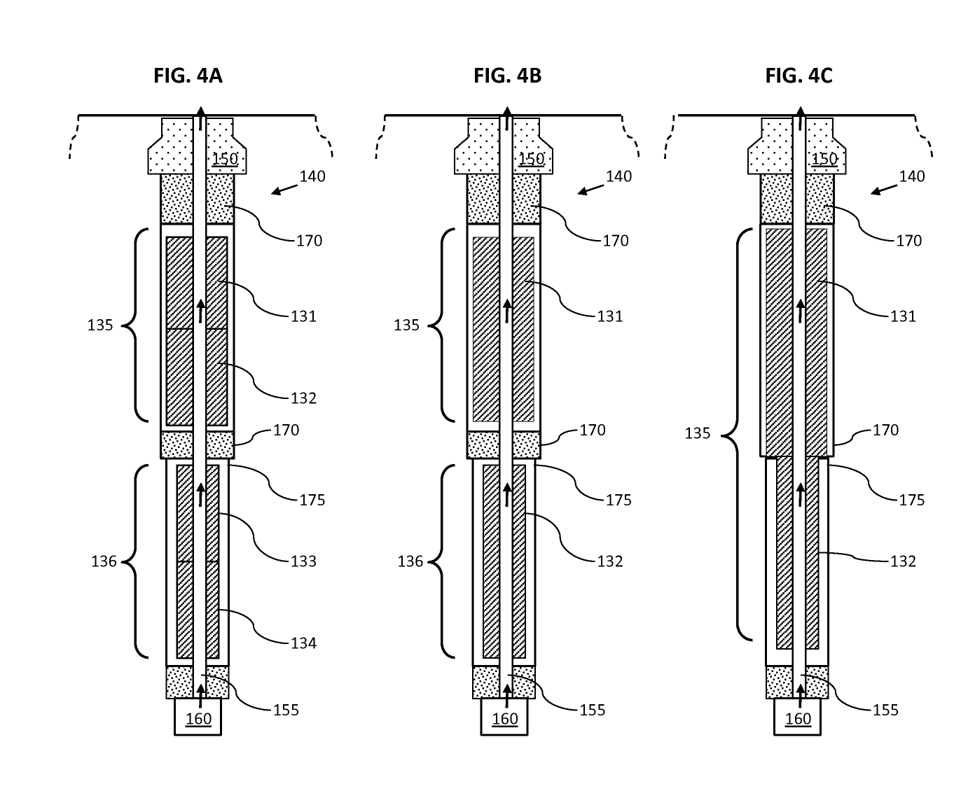

As shown in FIGS. 4A-C, in an embodiment, coils 135, 136 having turns 131, 132, 133, 134 may be held in place within slots 140 by retaining members 150. Retaining members 150 may comprise, for example, wedges which may be made of a steel alloy. As shown in FIG. 4A, first and second coils 135, 136 may be provided having two turns each, and may be arranged such that first coil 135 is disposed radially outward of second coil 136. Coil 135 may include first and second turns 131, 132, and coil 136 may also include third and fourth turns 133, 134. In further embodiments, more than two coils may be provided, and/or more than two turns per coil may be provided. As shown in FIG. 4B, in another embodiment, first and second coils 135, 136 may be provided having one turn each, and may also be arranged such that first coil 135 is disposed radially outward of second coil 136. Coil 135 may include first turn 131, and coil 136 may include second turn 132. As previously noted, in further embodiments, more than two coils may be provided. As shown in FIG. 4C, in a further embodiment, first coil 135 may be provided, having two turns. Coil 135 may include first turn 131 and second turn 132, which may be arranged such that first turn 131 is disposed radially outward of second turn 132. As previously noted, in further embodiments, more than two turns may be provided in coil 135.

In the embodiments shown in FIGS. 4A-C, turns 131-134 may be cooled directly, by gas traveling through passageway 155. The gas may be, for example, air or hydrogen which travels parallel to the Z-axis of rotor 120 (labeled in FIG. 1) through subslot 160, and is bled off. From subslot 160, it travels radially outward along passageway 155, directly contacting and cooling turns 131-134. Subslots 160 are disposed in rotor body 300 such that each subslot 160 extends axially through the rotor 120 parallel to the Z-axis of the rotor 120 (FIG. 1), and is in fluid communication with a radially inner end of a slot 140 (FIG. 2). Creepage blocks 170 may also be used to provide insulation to prevent flashover between turns. A passageway 155 extends substantially radially outwardly along each slot 140 for cooling the plurality of turns 131-134 disposed in the slot 140. Insulating material 175 may further be disposed about turns 131-134. In one embodiment, insulating material 175 may comprise mica tape. It is noted that any of the arrangements of coils 135, 136 and turns 131, 132, 133, 134 shown in FIGS. 4A-C may be applicable to the following embodiments.

In an embodiment shown in FIG. 5, passageway 155 may be provided with several offsets 156 along the length of the passageway 155. These offsets 156 provide at least one elbow or bend in the flow path through passageway 155, and create a convoluted path for gas to travel radially outwardly along slot 140. They also increase the length of passageway 155 along which cooling gas travels, as well as the surface area of turns 131-134 over which the gas passes, without requiring additional radial length.

As shown in FIGS. 6-7, an insulating insert 180 may further be provided disposed about passageway 155 at one of several locations about the radially extending length of slot 140. These locations include any location where prevention of flashover is particularly desired. Such locations include, but are not limited to: a junction between the first turn 131 and the retaining member 150 (A/B in FIG. 6), a junction between the third turn 133 and the second turn 132 (C/D in FIG. 6), and a junction between subslot 160 and the fourth turn 134 (E, FIG. 6). In other embodiments, additional locations may be dictated by the arrangements of coils 135, 136 and turns 131, 132, 133, 134. For example, in an embodiment having two coils 135, 136 each having one turn 131, 132 apiece (FIG. 4B), an insulating insert 180 may be provided at a location such as a junction between first turn 131 and second turn 132, or between second turn 132 and subslot 160. This is merely one additional example, and is not intended to be limiting.

As further shown in FIGS. 6-7, insulating insert 180 may include an insulating cylinder 181 disposed about passageway 155. Insulating cylinder 181 functions substantially like a sleeve around passageway 155. Insulating insert 180 may include insulating cylinder 181 alone, as in FIG. 7, or as shown in FIG. 6, it may further include an insulating plate 182. Insulating plate 182 is disposed such that it substantially bisects a longitudinal axis of the insulating cylinder 181, and lies substantially across passageway 155. It is noted that the portions of insulating cylinder 181 on either side of insulating plate 182 need not be equal, or even approximately equal in height. Insulating plate 182 includes a passageway or hole disposed through a center of the insulating plate 182 so that it does not occlude passageway 155. As further shown in FIG. 7, embodiments including insulating insert 180 may be used in combination with embodiments including offsets 156, described above with reference to FIG. 5.

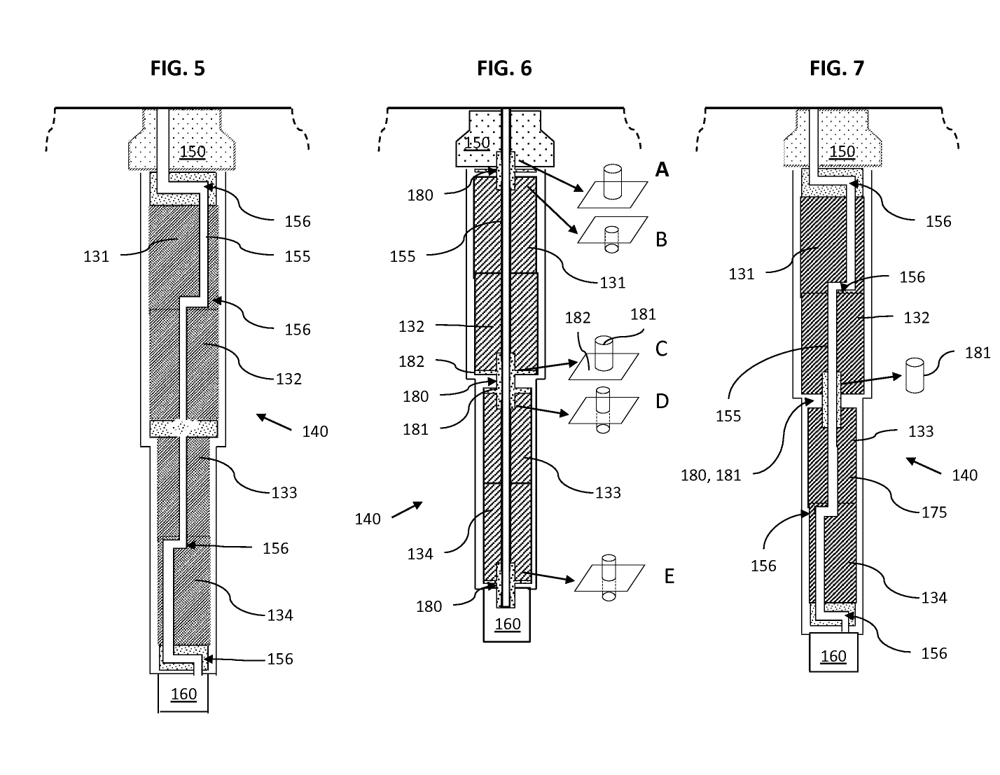

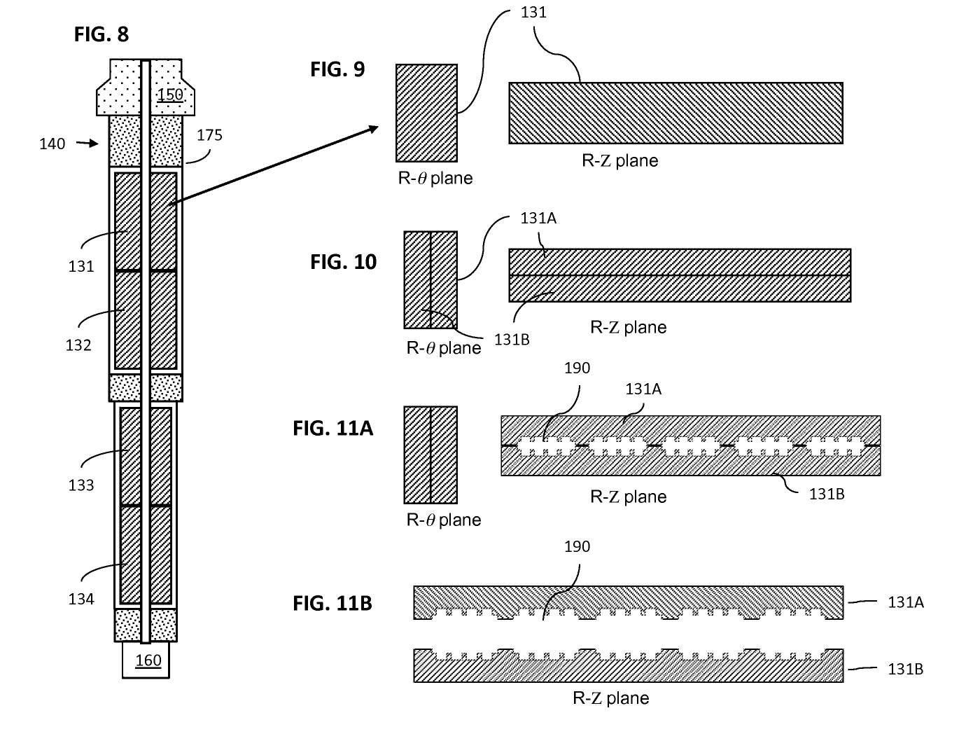

In a further embodiment, shown in FIGS. 8-11, turbulence-generating indentations 190 are provided for further increasing surface area along turns 131-134. FIGS. 9-11 illustrate the present embodiment with respect to turn 131 (FIG. 8), along the R-theta and R-Z planes as indicated. As shown in FIGS. 9-10, turn 131 is substantially bisected, dividing turn 131 into two approximate halves 131A-B substantially along the mid-plane of the rotor slot, which in turn is aligned along the R and Z axes (see FIG. 1). As shown in FIG. 11B, turbulence-generating indentations 190 are then machined into the mating surfaces of each of the halves A, B of the bisected turn 131. After turbulence-generating indentations 190 are machined into halves A, B of turn 131, halves 131A, 131B are placed back together as shown in FIG. 11A. It is noted that turbulence-generating indentations 190 are indentations in the mating faces of halves 131A, 131B of turn 131, for example, and may be irregular in depth, length, distance from one another, and overall shape of the features. These turbulence-generating indentations 190 serve to increase the total surface area of turn 131 that comes into contact with gas passing radially outward from subslot 160 out through retaining member 150 (FIG. 8). They further serve to increase turbulence in the gas, increasing its ability to cool the turn 131. It is further noted that turbulence-generating indentations 190 may be provided in each of turns 131-134, although only turn 131 is illustrated for purposes of brevity.

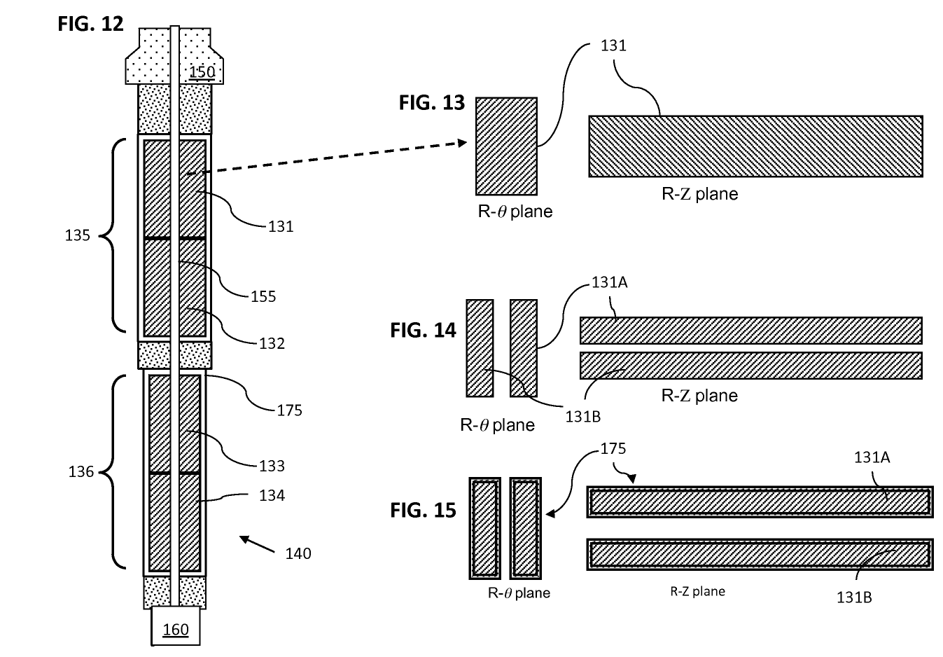

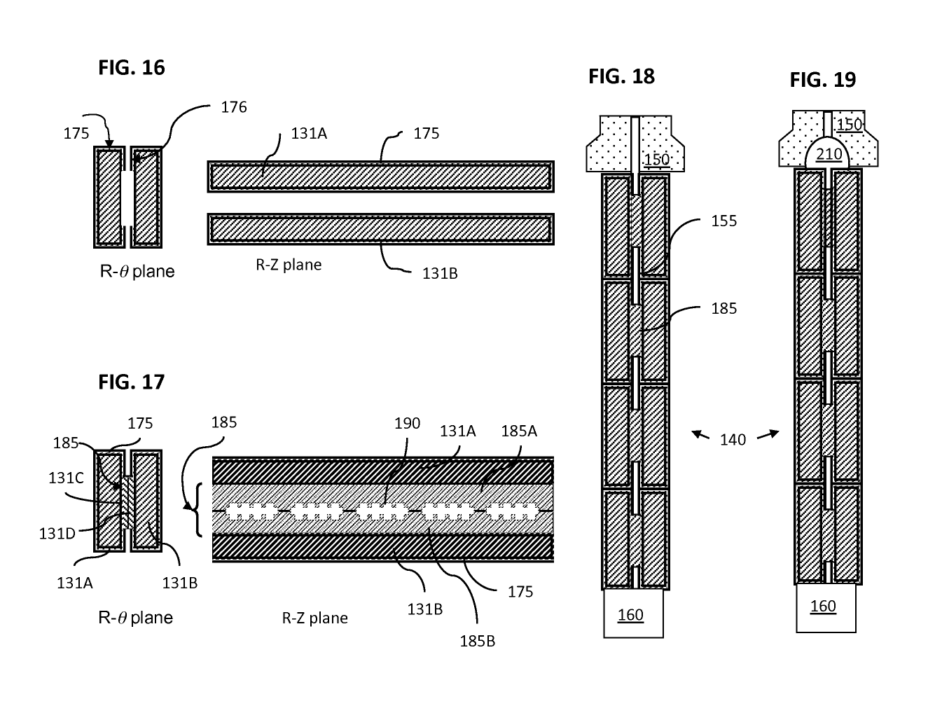

FIGS. 12-18 illustrate a further embodiment including turbulence-generating indentations 190. As above, FIGS. 13-17 illustrate the present embodiment with respect to turn 131, shown in FIG. 12, along the R-theta and R-Z planes as indicated. As shown in FIGS. 13-14, turn 131 is substantially bisected along the R and Z axes (see FIG. 1), dividing turn 131 into two approximate halves 131A-B with a gap there between for radially oriented ventilation (FIG. 14). As shown in FIG. 15, each half 131A, 131B is individually covered with insulating material 175. Insulating material 175 may be, for example, molded, wrapped, or extruded onto the portions of turn 131. As shown in FIG. 16, insulating material 175 is removed from a portion of the mating surfaces of each half 131A, 131B of turn 131. Enough radial length of insulating material 175 should be left to provide electrical creepage paths 176. As shown in FIG. 17, a spacer 185 is disposed between the mating surfaces of each half 131A, 131B of turn 131. Spacer 185, which may consist of two mating parts 185A and 185B, may be made of a conductive material such as, e.g., copper. As further shown in FIG. 17, spacer 185 includes a plurality of turbulence-generating indentations 190 for increasing surface area, substantially as described above with regard to the turbulence-generating indentations provided in FIG. 11. Like the turbulence-generating indentations 190 discussed with reference to FIG. 11, the turbulence-generating indentations 190 provided in FIG. 17 serve to increase the total surface area of turn 131 that comes into contact with gas passing radially outward from subslot 160 (FIG. 12) out through retaining member 150 (FIG. 12). They further serve to increase turbulence in the gas, increasing its ability to cool turn 131. Spacers 185 including turbulence-generating indentations 190 may be provided in each of turns 131-134, although only turn 131 is illustrated for purposes of brevity.

In the embodiment shown in FIG. 19, retaining member 150 is a wedge which further includes a recess 210 on a radially inward face. This recess 210 may provide improved ventilation through passageway 155. Recess 210 is illustrated in FIG. 19 in combination with the embodiment of FIG. 18, however, it may also be used in combination with any of the foregoing embodiments.

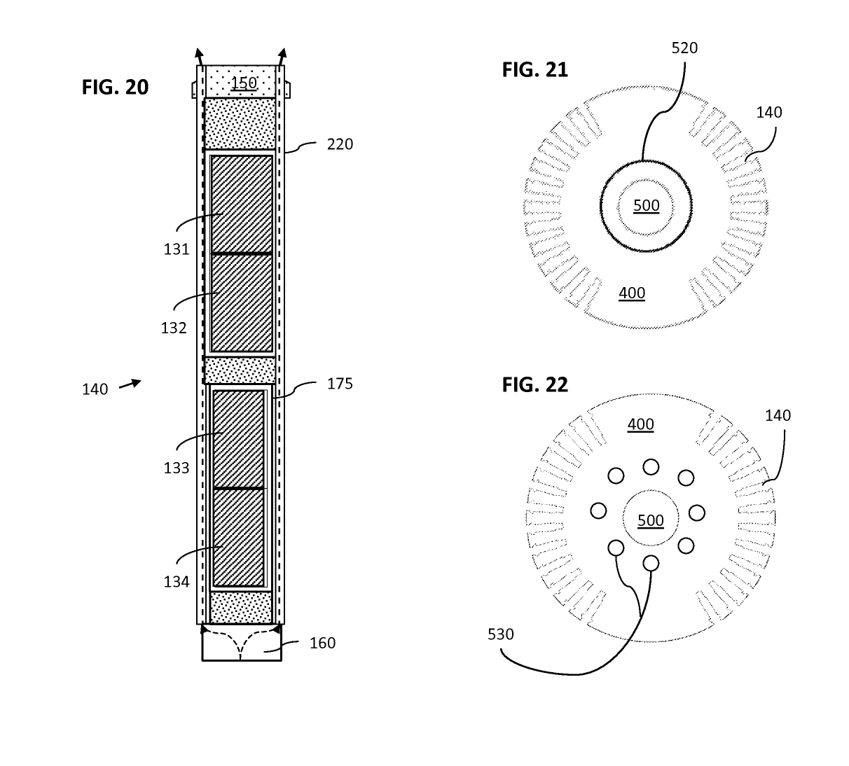

In a further embodiment, shown in FIG. 20, passageway 155 further comprises a pair of lateral ducts 220 disposed along an outer surface of the slot 140. Each of the pair of lateral ducts 220 is in fluid communication with the subslot 160. In this embodiment, turns 131-134 are cooled indirectly, i.e., heat is transferred through insulating material 175 to the cooling gas in lateral ducts 220 and carried radially outward.

In a further embodiment, any of the foregoing may be used to provide improved ventilation and electrical creepage to a laminated rotor. Laminated rotors are known in the art, and include a stack of laminations 400, examples of which are shown in FIGS. 21-22. Laminations 400 are stacked end to end with a central bore stud member 500 passing through a hole in a center of each lamination 400. The central hole runs through a full thickness of each lamination 400. Laminations 400 are compressed from the ends of the central stud to form rotor body 300 (labeled in FIG. 3).

In one embodiment, shown in FIG. 21, each lamination 400 includes an annular space 520 around the bore stud member 500. This annular space is substantially concentric with an outer diameter of each lamination 400 and the central bore stud member 500. Cooling gas is distributed to the slots 140 via radial passages in the laminations from the annular space 520 around the axial through stud.

Annular space 520 takes the place of individual subslots 160 in such an embodiment. When laminations 400 are stacked, the annular space 520 runs the axial length of rotor body 300. Cooling gas is provided to annular space 520 from one or both ends of rotor body 300. Annular space 520 is maintained in fluid communication with each slot 140 by a radially extending passage in at least one lamination 400. These radially extending passageways may be machined into a face of a lamination 400 prior to assembly, and may be at regular intervals, e.g., every nth lamination, and allow cooling gas to bleed out from annular space 520 outward through cooling passages 155 or lateral ducts 220 as appropriate.

In another embodiment, shown in FIG. 22, each lamination 400 includes a plurality of axially extending openings, or ducts, 530. The axially extending openings 530 are arranged about a central stud 500 passing axially through central hole in the laminations 400 that form rotor body 300 (FIG. 3). As with the foregoing embodiment, cooling gas is provided to axially extending openings 530 from one or both ends of rotor body 300. Axially extending openings 530 are maintained in fluid communication with slots 140 by at least one radially extending passage in at least one lamination 400. These radially extending passageways may be machined into a face of a lamination 400 prior to assembly, and may be at regular intervals, e.g., every nth lamination.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A rotor comprising:
a rotor body having a plurality of axially extending slots disposed radially about the rotor body;
at least one coil having at least one turn positioned within each of the plurality of axially extending slots,
a plurality of subslots disposed in the rotor body such that each subslot extends axially through the rotor body substantially parallel to an axis of rotation of the rotor body, and is in fluid communication with a radially inner end of a slot;
a passageway extending substantially radially outwardly along each axially extending slot for cooling the plurality of turns disposed in the slot; and
a retaining member in each of the slots for retaining the plurality of turns within the slot.

2. The rotor of claim 1, wherein the passageway further comprises at least one offset, wherein the at least one offset includes a bend in a flow path through the passageway.

3. The rotor of claim 1, wherein the passageway further includes an insulating cylinder disposed about the passageway proximate to at least one of:
a junction between the at least one subslot and the at least one coil;
a junction between the at least one coil and the retaining member; or
wherein the at least one coil further comprises at least two turns, a junction between a first turn and a second turn, wherein the second turn is radially outboard of the first turn.

4. The rotor of claim 3, further comprising
an insulating plate having a passageway disposed through a center of the insulating plate,
the insulating plate disposed such that it substantially bisects a longitudinal axis of the insulating cylinder.

5. The rotor of claim 1, wherein each of the at least one turns is bisected substantially along a mid plane of each of the plurality of axially extending slots, and, on mating surfaces of each of the bisected turns, includes a plurality of turbulence-generating indentations for increasing surface area,
wherein a gas passing through the passageway passes through the turbulence-generating indentations.

6. The rotor of claim 1, wherein each of the at least one turns is bisected substantially along a mid plane of each of the plurality of axially extending slots , and each half of each of the bisected turns is covered with an insulating material,
wherein the insulating material is removed from a portion of a mating surface of each half of each of the bisected turns, and
the rotor further comprises a conductive spacer disposed between the mating surfaces of each half of each of the bisected turns,
wherein the conductive spacer includes a plurality of turbulence-generating indentations for increasing surface area, and
wherein a gas passing through the passageway passes through the turbulence-generating indentations.

7. The rotor of claim 1, wherein the retaining member comprises a wedge, and wherein the wedge further includes a recess on a radially inward face.

8. The rotor of claim 1, wherein the passageway further comprises a pair of lateral ducts disposed along at least one outer surface of the slot, and each of the pair of lateral ducts is in fluid communication with the subslot.

9. The rotor of claim 1, wherein the rotor body further comprises:
a lamination stack, the lamination stack including a plurality of stacked laminations, each lamination having a first thickness, and
at least one stud member passing longitudinally through at least one hole in the lamination stack.

10. The rotor of claim 9, wherein the plurality of subslots further comprises an annular space in each lamination in the lamination stack, the annular space being substantially concentric with an outer diameter of the rotor body,
wherein the annular space is in fluid communication with each of the slots by a radially extending passage in at least one lamination.

11. The rotor of claim 9, wherein the plurality of subslots further comprises a plurality of axially extending openings in the lamination stack, the axially extending openings being arranged about a central stud passing axially through the rotor body,
wherein each of the slots is maintained in fluid communication with at least one of the axially extending openings by a radially extending passage in at least one lamination.

12. A dynamoelectric machine comprising:
a rotor including:
a rotor body having a plurality of axially extending slots disposed radially about the rotor body;
at least one coil having at least one turn positioned within each of the plurality of axially extending slots,
a plurality of subslots disposed in the rotor body such that each subslot extends axially through the rotor body parallel to an axis of rotation of the rotor body, and is in fluid communication with a radially inner end of a slot;
a passageway extending substantially radially outwardly along each axially extending slot for cooling the plurality of turns disposed in the slot; and
a retaining member in each of the slots for retaining the plurality of turns within the slot; and
a stator surrounding the rotor.

13. The electric machine of claim 12, wherein the passageway further comprises at least one offset, wherein the at least one offset includes a bend in a flow path through the passageway.

14. The electric machine of claim 12, wherein the passageway further includes an insulating cylinder disposed about the passageway proximate to at least one of:
a junction between the at least one subslot and the at least one coil;
a junction between the at least one coil and the retaining member; or
wherein the at least one coil further comprises at least two turns, a junction between a first turn and a second turn, wherein the second turn is radially outboard of the first turn.

15. The electric machine of claim 14, further comprising
an insulating plate having a passageway disposed through a center of the insulating plate,
the insulating plate disposed such that it substantially bisects a longitudinal axis of the insulating cylinder.

16. The electric machine of claim 12, wherein each of the at least one turns is bisected along a mid-plane of the rotor, and, on mating surfaces of each of the bisected turns, includes a plurality of turbulence-generating indentations for increasing surface area,
wherein a gas passing through the passageway passes through the turbulence-generating indentations.

17. The electric machine of claim 12, wherein each of the at least one turns is bisected substantially along a mid-plane of each of the plurality of axially extending slots, and each half of each of the at least one bisected turns is covered with an insulating material,
wherein the insulating material is removed from a portion of a mating surface of each half of each of the at least one bisected turns, and
the rotor further comprises a conductive spacer disposed between the mating surfaces of each half of each of the at least one bisected turns,
wherein the conductive spacer includes a plurality of turbulence-generating indentations for increasing surface area, and
wherein a gas passing through the passageway passes through the turbulence-generating indentations.

18. The electric machine of claim 12, wherein the retaining member comprises a wedge, and wherein the wedge further includes a recess on a radially inward face.

19. The electric machine of claim 12, wherein the rotor body further comprises:
a lamination stack, the stack including a plurality of stacked laminations, each lamination having a first thickness, and
at least one stud member passing longitudinally through at least one hole in the lamination stack.

20. The electric machine of claim 12, wherein the electric machine is a doubly-fed induction machine.
